(19) United States
(12) Patent Application Publication
(10) Pub. No.: US 2021/0015055 A1
(43) Pub. Date: Jan. 21, 2021

(54) AUTOMOBILE PLANT POT

(71) Applicant: Jonathan P. Ramirez, Woodland Hills, CA (US)

(72) Inventor: Jonathan P. Ramirez, Woodland Hills, CA (US)

(21) Appl. No.: 16/691,543

(22) Filed: Nov. 21, 2019

Related U.S. Application Data
(63) Continuation-in-part of application No. 16/512,282, filed on Jul. 15, 2019.

(51) Int. Cl. A01G 27/06; B60R 11/00; A01G 27/00

(52) U.S. Cl. CPC A01G 27/06; B60R 2011/0003; A01G 27/006; B60R 11/00

(57) ABSTRACT

An automobile plant pot includes a base and a planter. The base includes a first connector, a first opening, and a first reservoir in fluid communication with the first opening. The planter includes a second connector, a soil compartment, a second opening. The second opening is in fluid communication with the first opening and the soil compartment. The first connector and the second connector are adapted to interconnect so as to fix the planter to the base. A wick is arranged so as to extend from the first reservoir through the first and second openings to the soil compartment.

### CROSS REFERENCE TO RELATED APPLICATIONS

This application is a Continuation-In-Part of pending U.S. patent application Ser. No. 16/512,282, filed on Jul. 15, 2019, the entirety of which are incorporated by reference herein.

### BACKGROUND OF THE INVENTION

### Field of the Invention

The present invention relates to a plant pot, and in particular it relates to a plant pot adapted for display in the cupholder of an automobile.

### Description of the Related Art

The average American spends over one hour a day in a car. Full-time rideshare drivers and long-haul truckers may spend ten or more hours a day in their vehicles. To enhance the driving experience for both drivers and passengers, vehicle owners may accessorize the interior of the car with items to improve comfort and safety. Plants are considered to have both calming and health benefits for humans, but conventional plant pots cannot be conveniently or safely carried in a vehicle.

### BRIEF SUMMARY OF THE INVENTION

Embodiments of the present invention provide an automobile plant pot comprising a base and a planter. The base includes a first connector, a first opening, and a first reservoir in fluid communication with the first opening. The planter includes a second connector, a soil compartment, a second opening. The second opening is in fluid communication with the first opening and the soil compartment. The first connector and the second connector are adapted to interconnect so as to fix the planter to the base. Preferably, a diameter of the first opening is greater than a diameter of the second opening. In embodiments of the application, a wick is arranged so as to extend from the first reservoir through the first and second openings to the soil compartment. In preferred embodiments, the base and planter are adapted to fit into a cupholder of an automobile.

The planter may preferably further comprise a collection saucer arranged below the soil compartment, the collection saucer having a second reservoir, wherein the soil compartment comprises a third opening in fluid communication with the second reservoir. Preferably, the soil compartment and the collection saucer are integrally formed. In some embodiments, the base comprises a first tapered sidewall, and the collection saucer comprises a second tapered sidewall, and surfaces of the first and the second tapered sidewalls are substantially coplanar.

A detailed description of these and other features and embodiments of the invention are described in the following detailed description and illustrated in the attached figures.

### BRIEF DESCRIPTION OF THE DRAWINGS

The present invention can be more fully understood by reading the subsequent detailed description and examples with references made to the accompanying drawings, wherein:

FIG. 1 is a perspective view of an embodiment of an automobile plant pot of the present invention;

FIG. 2 is an exploded view of an automobile plant pot of the present invention;

FIG. 3 is a top view of the automobile plant pot of the present invention;

FIGS. 4-5 are cross-sectional views of the automobile plant pot of the present invention; and

FIG. 6 is bottom view of the planter portion of the automobile plant pot of the present invention.

### DETAILED DESCRIPTION OF THE INVENTION

In order to make the above objects, features and advantages of the embodiments of the present invention easier to understand, a detailed description is given in the following embodiments with reference to the accompanying drawings.

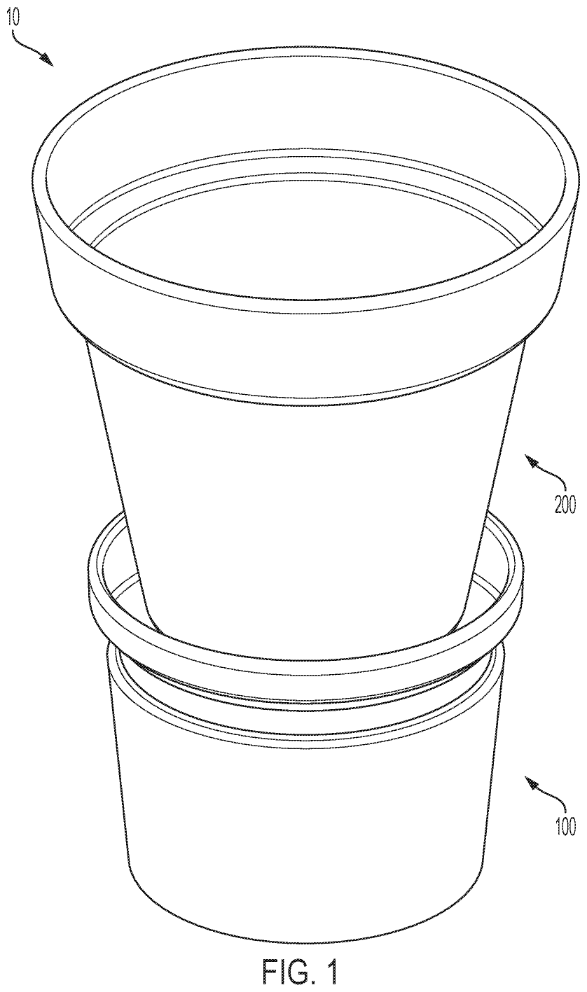

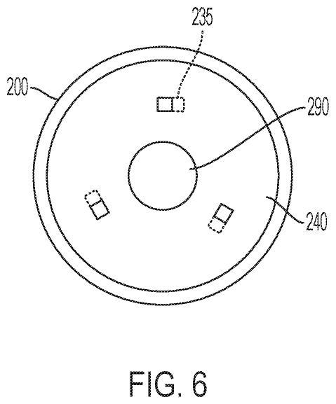

As shown in FIGS. 1-6, embodiments of an automobile plant pot 10 of the present invention comprise a base 100 and a planter 200. Suitable materials for the base 100 and planter 200 include plastic and ceramic, but the invention is not so limited.

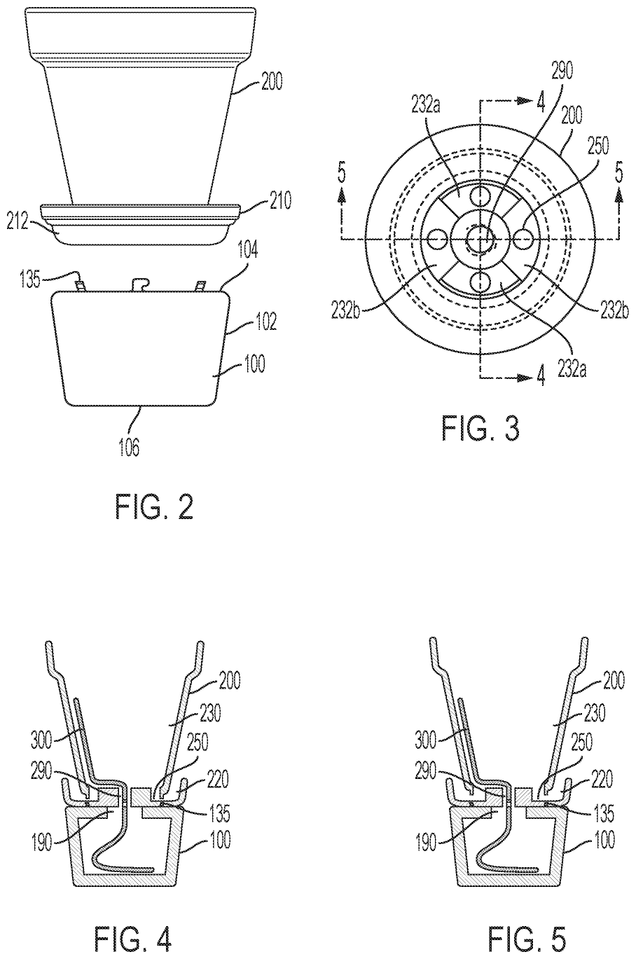

With reference to FIGS. 2 and 4-6, base 100 is provided with at least one connector 135 and planter 200 is provided with at least one connector 235. Connectors 135 and 235 are adapted to interconnect so as to fix planter 200 to base 100. In the illustrated embodiment, connectors 135 are hooks extending from a top wall 104 of base 100 and connectors 235 are complementary recesses formed in a bottom wall 240 of planter 200, the hooks and recesses arranged such that connectors 135 may be inserted into connectors 235 and then twisted to lock the planter 200 to base 100. When separating planter 200 from base 200, the connectors 235 and connectors 235 may be twisted in opposite directions and then pulled apart. It is further understood that the arrangement of these elements may be reversed. It is understood that in other embodiments of the present invention, other connecting elements may be used.

In a preferred embodiment, base 100 has a flat bottom wall 106. With reference to FIGS. 4-5, in embodiments of the application, base 100 further includes an opening 190 and a reservoir 130, while planter 200 includes an opening 290 and a soil compartment 230. Reservoir 130 is adapted to receive water or other liquids. Soil compartment 230 is adapted to receive a plant medium, such as soil or small stones, and a plant. As shown in the figures, the reservoir 130 is in fluid communication with opening 190, opening 190 is in fluid communication with opening 290, and opening 290 is in fluid communication with soil compartment 230. In preferred embodiments, the diameter of the opening 190 in base 100 is greater than the diameter of the opening 290 in planter 100. In embodiments of the application, the diameter of opening 290 is between ¼ inches and ½ inches. In a preferred embodiment, the diameter of opening 290 ⅜ of an inch. It is understood that in other embodiments the diameters may the same, or the diameter of the opening 290 in planter 200 may be greater that the diameter of the opening 190 is base 100.

In preferred embodiments, automobile plant pot 10 further includes a wick 300. As illustrated in FIGS. 4-5, wick 300 is arranged so as to extend from the reservoir 130 through openings 190/290 to soil compartment 230. The wick may be a strip of any suitable porous material and is arranged for drawing water or other liquids from reservoir 130 to soil compartment 230 by capillary action. As shown in the drawing, wick 300 preferably extends at least to the bottom of reservoir 130 and has sufficient length to reach up into the center of soil compartment 230, such that water will be drawn from the bottom of reservoir 130 to the plant medium and roots of the plants in soil compartment 230. In embodiments of the application, wick 300 is a cotton strip with a diameter that is less that the diameter of opening 290.

In embodiments of the application, planter 200 includes a collection saucer 210. As shown in FIGS. 3-5, at least one opening 250 is formed in soil compartment 230 to be in fluid communication with an open reservoir 220 of collection saucer 210, allowing for drainage of water from soil compartment 230 to the collection saucer 210. In a preferred embodiment, soil compartment 230 and the collection saucer 210 are integrally formed, though it is understood that in other embodiments these elements may be removably attached.

FIG. 4 is a cross-sectional view of FIG. 3 along the line 4-4. FIG. 5 is a cross-sectional view of FIG. 3 along the line 5-5. As shown in FIGS. 3, 4 and 5, the bottom surface in the illustrated embodiment is staggered, having two lower surfaces 232a and two higher surfaces 232b. In other embodiments, the bottom surface of the soil compartment 230 is flat. In the figures, four openings 250 in a bottom surface of soil compartment 230 are shown, but the invention is not so limited. In other embodiments, more or fewer openings may be provided, and/or the openings may be provided in a lower sidewall of the planter.

The dimensions of base 100 and planter 200 are selected such that the automobile plant pot fits into a cupholder of an automobile. For example, in preferred embodiments, a height of base 100 is 1.5-2 inches and the height of planter 200 is 3.25-3.75 inches. However, it is understood that in other embodiments, different dimensions may be used to correspond to cupholders of various automobiles, preferably with a ratio of about 1 to 2 in the height of the base relative to the planter. For example, in another larger embodiment, a height of base 100 is 2-2.5 inches and the height of planter 200 is 4-5 inches.

As shown in FIGS. 1-2, the sidewall 102 of the base and sidewall 212 of the collection saucer are not substantially coplanar. It is understood that in other embodiments of the application, these sidewalls may be substantially coplanar (as illustrated in FIGS. 4 and 5).

As described above, embodiments of the present application provide a safe and convenient way to transport a plant in the cupholder of a vehicle. The reservoir interior to the base and the arrangement of the wick extending between this reservoir and the soil compartment allow for water to be continuously drawn into the soil compartment by capillary action. Moreover, there is less need to check for saturation, and the water supply from the reservoir interior to the base decreases the number of times the plant needs to be watered as well as the potential for spillage. The open reservoir in the saucer allows for evaporation of excess water. The disclosed automobile plant pots are held securely in an automobile cupholder. Moreover, use of the base and planter elements in the preferred dimensions disclosed in the present application allow for stable and secure transportation of the disclosed automobile plant pots both inside and outside of the vehicle.

It is understood that features of the embodiments described above allow persons having ordinary skill in the art to clearly appreciate the form of the present specification. Persons having ordinary skill in the art can appreciate that the objectives and/or the advantages of the above embodiments can be accomplished in a manner consistent with the above embodiments by designing or modifying other processes and structures based on the content of the present disclosure. Persons having ordinary skill in the art can also appreciate that the equivalent constructions without departing from the scope and spirit of the present invention can be modified, substituted or retouched without departing from the scope and spirit of the present invention.

What is claimed is:

1. An automobile plant pot apparatus, comprising:
a base, the base comprising:
a first connector;
a first opening; and
a first reservoir in fluid communication with the first opening;
a planter, the planter comprising:
a soil compartment; and
a second opening, wherein the second opening is in fluid communication with the first opening and the soil compartment; and
a second connector, wherein the first connector and the second connector are adapted to interconnect so as to fix the planter to the base; and
a wick, arranged so as to extend from the first reservoir through the first and second openings to the soil compartment.

2. The automobile plant pot of claim 1, wherein a diameter of the first opening is greater than a diameter of the second opening.

3. The automobile plant pot of claim 1, wherein the planter further comprises a collection saucer arranged below the soil compartment and comprising a second reservoir, wherein the soil compartment comprises a third opening in communication with the second reservoir.

4. The automobile plant pot of claim 3, wherein the soil compartment and the collection saucer are integrally formed.

5. The automobile plant pot of claim 1, wherein the base and planter are adapted to fit into a cupholder of an automobile.

6. The automobile plant pot of claim 1, wherein one of the first and second connectors is a hook, and the other of the first and second connectors is a recess adapted to engage with the hook.

7. The automobile plant pot of claim 1, wherein the wick is arranged to draw water disposed in first reservoir to the soil compartment by capillary action.

8. The automobile plant pot of claim 1, wherein the base comprises a first tapered sidewall, and the collection saucer comprises a second tapered sidewall, and surfaces of the first and the second tapered sidewalls are substantially coplanar.

9. An automobile plant pot apparatus, comprising:
a base, the base comprising:
a first connector;
a first opening; and
a first reservoir in fluid communication with the first opening;
a planter, the planter comprising:
a soil compartment; and
a second opening, wherein the second opening is in fluid communication with the first opening and the soil compartment; and
a second connector, wherein the first connector and the second connector are adapted to interconnect so as to fix the planter to the base.

10. The automobile plant pot of claim 9, wherein a diameter of the first opening is greater than a diameter of the second opening.

11. The automobile plant pot of claim 9, wherein the planter further comprises a collection saucer arranged below the soil compartment and comprising a second reservoir, wherein the soil compartment comprises a third opening in communication with the second reservoir.

12. The automobile plant pot of claim 11, wherein the soil compartment and the collection saucer are integrally formed.

13. The automobile plant pot of claim 9, wherein the base and planter are adapted to fit into a cupholder of an automobile.

14. The automobile plant pot of claim 9, wherein one of the first and second connectors is a hook, and the other of the first and second connectors is a recess adapted to engage with the hook.

15. The automobile plant pot of claim 9, wherein the base comprises a first tapered sidewall, and the collection saucer comprises a second tapered sidewall, and surfaces of the first and the second tapered sidewalls are substantially coplanar.
